(19) United States
(12) Patent Application Publication
(10) Pub. No.: US 2008/0036992 A1
(43) Pub. Date: Feb. 14, 2008

(54) EXPOSURE APPARATUS AND DEVICE MANUFACTURING METHOD

(75) Inventors: Kenichiro Mori, Utsunomiya-shi (JP); Tomoaki Kawakami, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/837,113

(22) Filed: Aug. 10, 2007

(30) Foreign Application Priority Data
Aug. 14, 2006 (JP) 2006-221241(PAT.)

(51) Int. Cl. G03B 27/72

(52) U.S. Cl. 355/71

(57) ABSTRACT

An exposure apparatus comprises an illumination optical system and a projection optical system. The illumination optical system includes an optical integrator configured to emit a plurality of light fluxes from an exit surface thereof, a diffraction optical element configured to form a predetermined light intensity distribution on an incident surface of the optical integrator, and a polarization optical element configured to adjust a polarization state of the incident light. The polarization optical element has a pattern with which the polarization optical element functions as a birefringent element, the pattern changing in density between a first direction and a second direction perpendicular to the first direction, and having a sub wavelength structure having a cycle not more than a wavelength of the light from the light source, and the polarization optical element is arranged near or on the incident surface on which the diffraction optical element forms the light intensity distribution.

### BACKGROUND OF THE INVENTION

1. Field of the Invention

The present invention relates to an exposure apparatus which projects a pattern of a mask onto a substrate via a projection optical system to expose the substrate, and a device manufacturing method.

2. Description of the Related Art

A projection exposure apparatus is used in a lithography step of manufacturing a semiconductor device. The lithography step includes a step of transferring the circuit pattern of the semiconductor device onto a substrate (e.g., a silicon substrate or glass substrate) coated with a photosensitive agent.

In recent years, the micropatterning of semiconductor devices has advanced to the degree that a pattern having a line width of 0.15 μm or less is transferred. This advance has improved the degree of integration of semiconductor devices to achieve high-performance semiconductor devices with low power consumption. Further micropatterning requires an improvement in the resolution of projection exposure apparatuses.

The relationship among a resolution R (a line-and-space pitch that allows transfer), a numerical aperture (NA) of a projection optical system, and an exposure wavelength λ is given by:

R=k1·λ/NA (1)

where k1 is a coefficient.

As is obvious from equation (1), to enhance the resolution (to decrease the value R), it suffices to decrease the wavelength λ or increase the numerical aperture NA of the projection optical system. For this purpose, the increasing in the NA of the projection optical system and the shortening of the exposure wavelength have progressed conventionally.

Unfortunately, the recent study has revealed that a higher NA poses a problem that P-polarized light components (light components in which the electric field vector of light which strikes the surface of a substrate lies on a plane including the light and the normal to the substrate) decrease the contrast of interference fringes in the resist. Under the circumstances, to improve the resolution by increasing the NA, it is necessary to not only increase the NA but also attain polarization illumination for illuminating a mask with an S-polarized light component (a light component whose electric field vector is perpendicular to that of a P-polarized light component) by removing the P-polarized light component.

FIG. 8 is a view showing the arrangement of a conventional projection exposure apparatus comprising an optical system which forms polarization illumination. A light source 1 emits illumination light (exposure light). The light source 1 generally uses an excimer laser. A half waveplate 2 is made of a glass material such as quartz or magnesium fluoride having birefringence. The half waveplate 2 converts the polarized light applied from the light source 1 into polarized light whose electric field vector is in a predetermined direction. The half waveplate 2 can move to switch between a mode of illuminating the illumination target surface by X-polarization and a mode of illuminating it by Y-polarization. The X-polarization here indicates a mode of illuminating a mask with linearly polarized light having an electric field vector in the X direction of the exposure apparatus. The Y-polarization here indicates a mode of illuminating a mask with linearly polarized light having an electric field vector in the Y direction of the exposure apparatus. A neutral density filter (ND) 3 can be switched to change the illuminance of illumination light in accordance with the sensitivity of a photosensitive agent applied to a substrate 17.

A microlens array 4 guides light from the light source I to emerge with a specific angular distribution so as not to change the characteristic of the light to be applied to optical systems subsequent to the microlens array 4 even when it deviates from the optical axis of the illumination optical system due to vibration of the floor or exposure apparatus. A first condenser lens 5 projects the light from the microlens array 4 onto a CGH (computer generated hologram) 61. The CGH 61 generates diffracted light to form a light distribution based upon design on a plane A via a second condenser lens 7.

A microlens array 62 is exchangeable with the CGH 61. When the microlens array 62 is inserted in the optical path, it forms a uniform light distribution on the plane A via the second condenser lens 7. A variable magnification relay lens 8 enlarges/reduces the light distribution formed on the plane A, and projects it onto a fly-eye lens 10.

The fly-eye lens 10 may be, e.g., a group of rod lenses or an integrally formed microlens array. A third condenser lens 11 superimposes the light beams wavefront-split by the fly-eye lens 10 to form an almost uniform light distribution on a plane B. A half mirror 12 divides the light toward a sensor 13 for exposure amount control. A relay optical system 14 projects the almost uniform light distribution formed on the plane B onto a mask (reticle) 15.

A projection optical system 16 projects the circuit pattern of the mask 15 onto a substrate 17 coated with a photosensitive agent. A substrate stage 19 aligns the substrate 17. For example, the substrate stage 19 can be scan-driven to scan-expose the substrate 17 and driven step by step to change the exposure target shot region. An illuminometer 18 is mounted on the substrate stage 19. The illuminometer 18 is positioned within an exposed field by driving the substrate stage 19, and used to measure the illuminance within the exposed field. A control unit 20 controls the light source 1 on the basis of the output from the sensor 13, so that the exposure amount becomes a desired exposure amount.

The above example attains polarization illumination in the following way. That is, the half waveplate 2 adjusts the polarization state of light emitted by the light source 1 to a desired polarization state. The subsequent optical systems guide the light to strike the substrate 17 while minimizing the birefringence of the glass material and maintaining a given degree of polarization.

In addition to the above example, there is available another polarization illumination attainment method of extracting a specific polarized light component from illumination light using a linear polarizer.

The linear polarizer is used for, e.g., sunglasses and transmits only predetermined linearly polarized light. A linear polarizer is made of, e.g., plastic and hence has poor transmittance of ultraviolet light used as the light source of the exposure apparatus. It is therefore impractical to use the linear polarizer to form polarization illumination in the exposure apparatus.

There is also available an approach using, as a polarizer, an SWS (Sub Wavelength Structure) having a cycle equal to or less than the wavelength of incident light. For example, assume an SWS on which a fine line-and-space pattern having a cycle equal to or less than the wavelength of incident light is formed. The SWS transmits a polarized light component having an electric field vector in the direction in which the line-and-space pattern extends, while it reflects a polarized light component having an electric field vector perpendicular to that of the former. That is, such an SWS exhibits the characteristic of a polarizer. Using the SWS as a polarizer solves the above problem that a polarizer cannot cope with ultraviolet light. However, among all the components of illumination light, the SWS reflects and wastes any components other than desired polarized light components to result in a decrease in imaging plane illuminance, and eventually, a decrease in throughput.

In polarization illumination using a waveplate, it must be manufactured to generate an accurate phase difference. A half waveplate 101 made of a birefringent glass material will be explained with reference to FIG. 1. Let d be the thickness of the waveplate, ΔN be the birefringence amount of the glass material, and λ be the wavelength of exposure light. Then, the half waveplate 101 must be manufactured to satisfy a phase difference δφ=m+1/2. Since the phase difference significantly changes even when the thickness d of the waveplate deviates by only several μm, the thickness must be accurately controlled. This results in a very high cost.

To generate an accurate phase difference using a waveplate made of a birefringent glass material, it is also necessary to narrow down the range of incident angle. As shown in FIG. 1, when light strikes, at an angle θ, a waveplate which applies a predetermined phase to vertical light, the length of the optical path in the waveplate becomes longer than when the light vertically strikes the waveplate. For this reason, the exit light has a phase error of Δ to result in a failure in the generation of a desired phase difference.

Assume that light angularly strikes a pair of waveplates (zero-order half wavelength plates) 201 made of a birefringent glass material as shown in FIG. 2. In this case, simulation calculation of the purity of polarization by changing the thickness of the waveplate 201 yields the result shown in FIG. 3.

The purity of polarization is defined as Ix/(Ix+Iy) where Ix is the intensity of a light component which oscillates in a direction perpendicular to the sheet surface, and Iy is the intensity of a light component which oscillates in a direction parallel to the sheet surface. FIG. 3 shows the relationship between the purity of polarization and the thickness d (mm) of the waveplate. Referring to FIG. 3, the abscissa and ordinate indicate the incident angles of light with respect to the waveplate in the x and y directions, and the color indicates a change in the purity of polarization. A white portion indicates a high degree of polarization, and a black portion indicates a low degree of polarization. This result reveals that the phase difference A depends on the thickness of the waveplate. The thicker the waveplate, the larger the change in the purity of polarization with respect to the incident angle. For this reason, using a thick waveplate in the exposure apparatus lowers the purity of polarization of the irradiation target surface to result in a decrease in the image contrast. This reduces an ED window (Exposure Defocus Window) to result in degradation in the yield of a chip. The exposure apparatus desirably uses a thin (preferably, 0.5 mm or less) waveplate as a waveplate made of a birefringent glass material.

An increase in the NA of the exposure apparatus is thought to increasingly progress in the future. The angular distribution range of light in the illumination optical system is also predicted to widen. Meanwhile, for the above reasons, a waveplate made of a birefringent glass material must be arranged at a place where the angular distribution is relatively uniform to attain accurate polarization illumination. This limits the setting place of the waveplate, so it may become difficult to design an optical system which forms polarization illumination with high purity of polarization.

To meet another demand for obtaining an appropriate image of a specific mask pattern, custom polarization illumination for irradiating the irradiation target surface with illumination light whose polarization state changes between plural regions in its pupil is becoming desirable. To attain the custom polarization illumination using the above-described waveplate made of a birefringent glass material, it is necessary to set a combination of waveplates having fast axes in various directions on the pupil plane of the illumination optical system, a plane conjugate to the pupil plane, or a plane almost equivalent to them. Since a birefringent glass material has a fast axis in a direction attributed to that specific glass material, one waveplate has a fast axis in one direction. It is therefore necessary to set, on a stained glass, a combination of a plurality of waveplates made of a birefringent glass material. However, the formation of a complicated polarization state requires a plurality of waveplates and lowers the illuminance due to vignetting by the holding member to a nonnegligible extent. It is also necessary to make an angular distribution at a position conjugate to the pupil plane uniform because of the above-described limitation on the incident angle with respect to the waveplate to result in a lot of constraints on design. It is therefore hard for the above-described techniques to form complicated polarization illumination.

### SUMMARY OF THE INVENTION

The present invention has been made in consideration of the above problems, and has as its object to, e.g., provide an exposure apparatus having a function of changing the polarization state of light applied from a light source to an arbitrary polarization state with a low light amount loss.

A first aspect of the present invention relates to an exposure apparatus comprising an illumination optical system configured to illuminate a mask with light from a light source, and a projection optical system configured to project a pattern of the mask illuminated by the illumination optical system onto a substrate. The illumination optical system includes an optical integrator configured to emit plural light fluxes from an exit surface of the optical integrator, a diffraction optical element configured to form a predetermined light intensity distribution on an incident surface of the optical integrator, and a polarization optical element configured to adjust a polarization state of an incident light. The polarization optical element has a pattern with which the polarization optical element functions as a birefringent element, the pattern with different density between a first direction and a second direction perpendicular to the first direction, and having a sub wavelength structure having a cycle not more than a wavelength of the light from the light source, and the polarization optical element is arranged near or on the incident surface on which the diffraction optical element forms the light intensity distribution.

A second aspect of the present invention relates to a device manufacturing method. The method includes the steps of exposing a substrate coated with a photosensitive agent to light using the above-described exposure apparatus, and developing the substrate.

According to the present invention, for example, an exposure apparatus having a function of changing the polarization state of light applied from a light source to an arbitrary polarization state with a low light amount loss is provided.

Further features of the present invention will become apparent from the following description of exemplary embodiments with reference to the attached drawings.

### BRIEF DESCRIPTION OF THE DRAWINGS

FIG. 1 is a view showing a conventional waveplate;

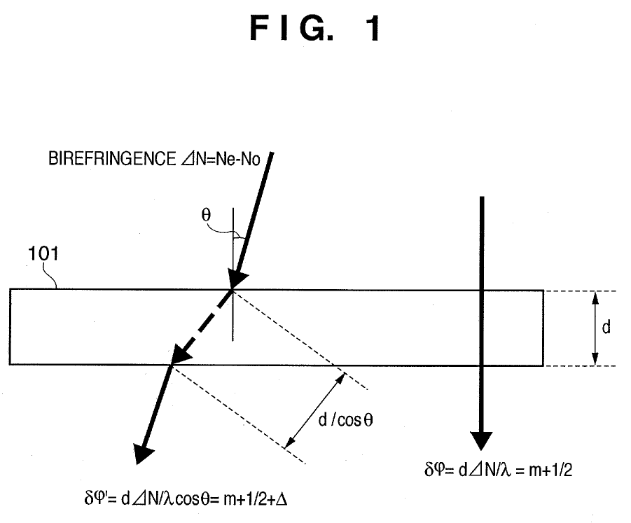

FIG. 2 is a schematic view related to the calculation of the purity of polarization by the conventional waveplate;

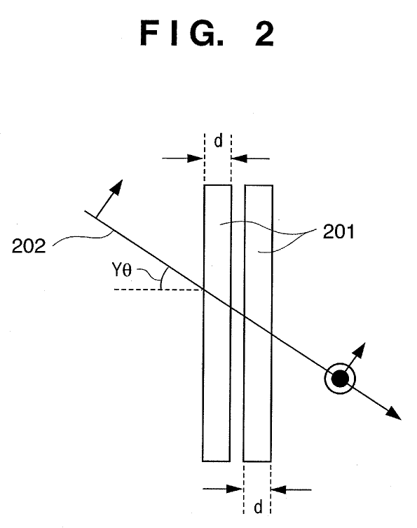

FIG. 3 is a view showing the calculation result of the purity of polarization when using the conventional waveplate;

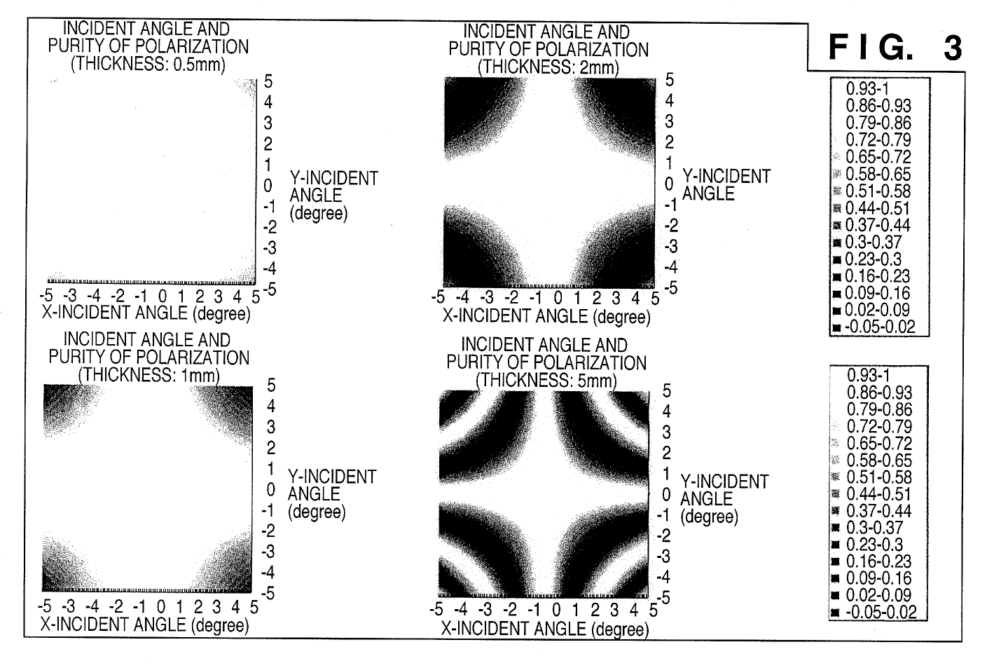

FIGS. 4A, 4B, and 4C are views showing an optical element having a birefringent structure according to a preferred embodiment of the present invention;

FIGS. 5A, 5B, and 5C are views illustrating polarization illumination according to the first embodiment of the present invention;

FIG. 6 is a view showing the schematic arrangement of an exposure apparatus according to the first embodiment of the present invention;

FIGS. 7A, 7B, and 7C are views schematically showing a polarization optical element according to the first embodiment of the present invention;

FIG. 8 is a view showing the arrangement of a conventional projection exposure apparatus comprising an optical system which forms polarization illumination;

FIG. 9 is a view showing the schematic arrangement of an exposure apparatus according to the second embodiment of the present invention;

FIG. 10 is a view showing a preferable polarization state in the pupil of a projection optical system;

FIGS. 11A and 11B are views schematically showing a polarization optical element according to a preferred embodiment of the present invention;

FIG. 12 is a view showing the schematic arrangement of an exposure apparatus according to the third embodiment of the present invention;

FIGS. 13A, 13B, 13C, and 13D are explanatory views showing a hologram to which a polarization optical element according to the third embodiment of the present invention is added;

FIG. 14 is a view showing the schematic arrangement of an exposure apparatus according to the fourth embodiment of the present invention;

FIG. 15 is a flowchart illustrating the sequence of the overall semiconductor device manufacturing process; and

FIG. 16 is a flowchart illustrating the detailed sequence of the wafer process.

### DESCRIPTION OF THE EMBODIMENTS

A preferred embodiment of the present invention will be described below.

The preferred embodiment of the present invention attains custom polarization illumination using a polarization optical element on which a sub wavelength structure is formed by, e.g., etching. The sub wavelength structure has a pattern that changes in density between the first direction and the second direction perpendicular to the first direction, and has a cycle equal to or less than the wavelength. The cycle of the sub wavelength structure is set smaller than a value obtained by dividing the wavelength of incident light by the refractive index to form a density pattern in an arbitrary direction.

The method using an SWS as a polarizer has been introduced as the prior art. In contrast, the present invention utilizes another aspect of the SWS, i.e. its characteristic capable of freely changing the refractive index.

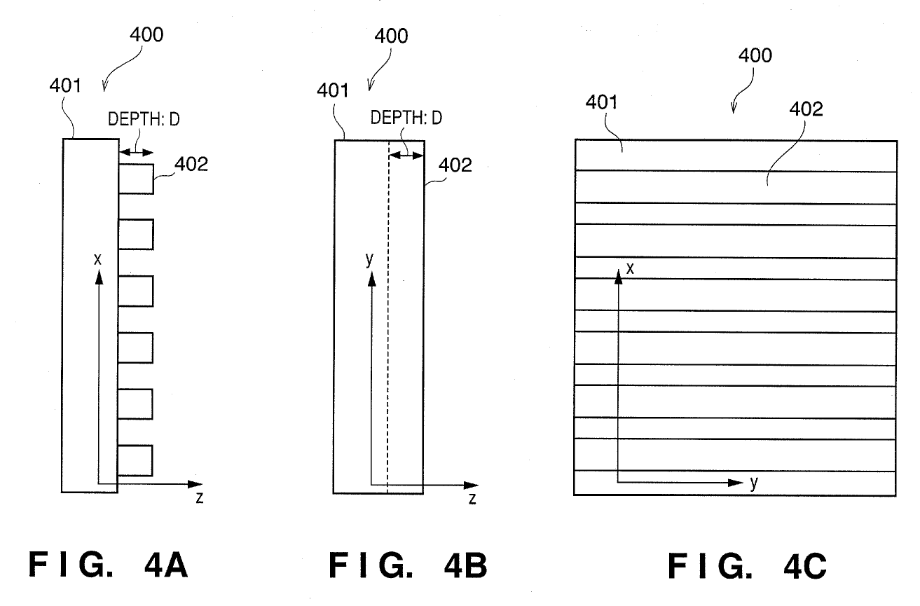

FIGS. 4A, 4B, and 4C are views showing a polarization optical element formed by etching the surface of a glass substrate into a density pattern. A density pattern 402 formed on a glass substrate 401 has the density difference between two perpendicular directions. Of the two perpendicular directions, one is defined as the x-axis and the other is defined as the y-axis. For the sake of simplicity, FIGS. 4A, 4B, and 4C exemplify fine gratings extending in the y direction.

Polarized light components in respective electric field directions experience different refractive indices in accordance with the density of the pattern formed on the glass substrate 401. This can be understood in the following way. That is, the cycle of the sub wavelength structure is so short as compared to the wavelength that light cannot feel it as if it were hollow. Hence, the light experiences a low glass density and refractive index. In other words, letting N be the refractive index of the glass substrate, both polarized light components having electric field vectors in the x and y directions have an equal refractive index N in a region (a place deeper than a depth D) with no sub wavelength structure formed. On the other hand, in a region where a sub wavelength structure is formed, a polarized light component having an electric field vector in the x direction experiences a low glass density and therefore has a refractive index Nx lower than that of the glass. Also in a region where a sub wavelength structure is formed, a polarized light component having an electric field vector in the y direction experiences a refractive index Ny different from the refractive index Nx because the glass density is different from that in the x direction. Referring to FIGS. 4A, 4B, and 4C, no pattern is present in the y direction, so the refractive index Ny is equal to the refractive index N of the glass having no pattern formed. When the density of the density pattern changes between the two directions, it is possible to differentiate the refractive indices Nx and Ny. If the density of the pattern in the y-axis direction is lower than that in the x-axis direction, the relationship with the refractive index N of the glass plate having no pattern is given by N>Nx, N≧Ny, and Nx<Ny.

A polarization optical element 400 having a sub wavelength structure thus etched functions as a birefringent element. A light component whose electric field vector is in the direction (x direction) in which the refractive index is low has a phase faster than that of a light component whose electric field vector is in the direction (y direction) in which the refractive index is high. For this reason, the polarization optical element 400 serves as a birefringent element having a fast axis in the x direction. Utilizing this action makes it possible to use an optical element micropatterned at a cycle equal to or less than the light wavelength as a waveplate which efficiently forms arbitrary polarization.

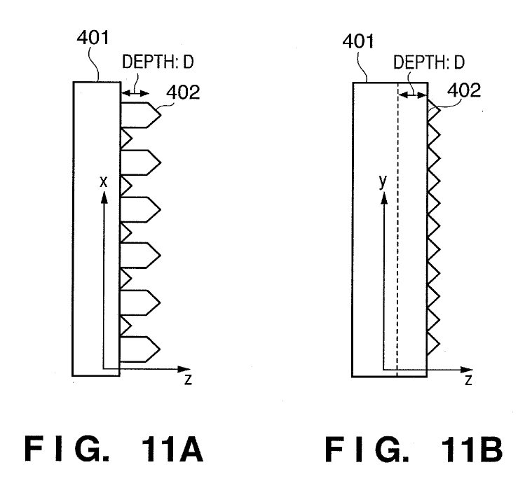

As shown in FIGS. 11A and 11B, when the sub wavelength structure includes pyramids, the refractive index continuously changes from that of the substrate to that of the air. In this case, the polarization optical element 400 is imparted with the characteristic of an anti-reflection element. The anti-reflection element using the sub wavelength structure is more excellent in both frequency and angular characteristics than a normal anti-reflection film.

Using the above-described optical element converts the polarization state of light from a light source into a predetermined polarization state. This makes it possible to irradiate the irradiation target surface with high illuminance and low light amount loss.

In the arrangement illustrated in FIGS. 4A, 4B, and 4C, only a portion corresponding to the depth D generates a phase difference. Even when high-NA light strikes a waveplate made of a birefringent glass material, high purity of polarization can be obtained as in the case wherein the waveplate is very thin.

To form arbitrary polarization illumination, the preferred embodiment of the present invention can obtain a target polarization optical element by etching the surface of a glass substrate. According to the preferred embodiment of the present invention, it is possible to more easily form waveplates having arbitrary fast axis directions in a plurality of regions to obtain arbitrary polarization illumination, as compared to a method of controlling the polarization state by a plurality of polarizers or an optical element as a combination of waveplates.

The anti-reflection element using the sub wavelength structure is also more excellent in angular characteristic than a normal multi-layered reflection film, and hence is suited to be set at various places.

Such a polarization optical element is suitable as a constituent component of an exposure apparatus which exposes a substrate to light by causing an illumination optical system to illuminate a mask with light applied from a light source, and projecting the pattern of the mask onto the substrate via a projection optical system. The polarization optical element is inserted in the optical path from the light source to the substrate and can function to control the polarization state of light.

Exemplary embodiments of the present invention will be described below.

### First Embodiment

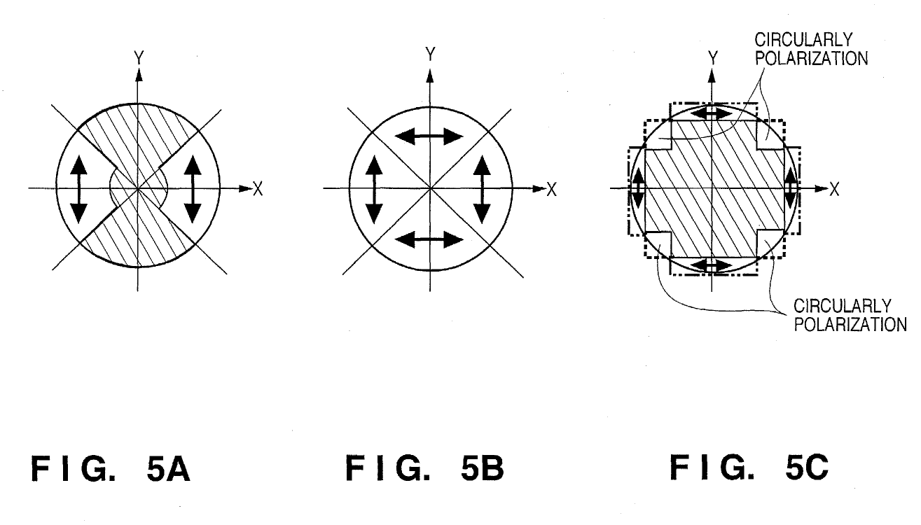

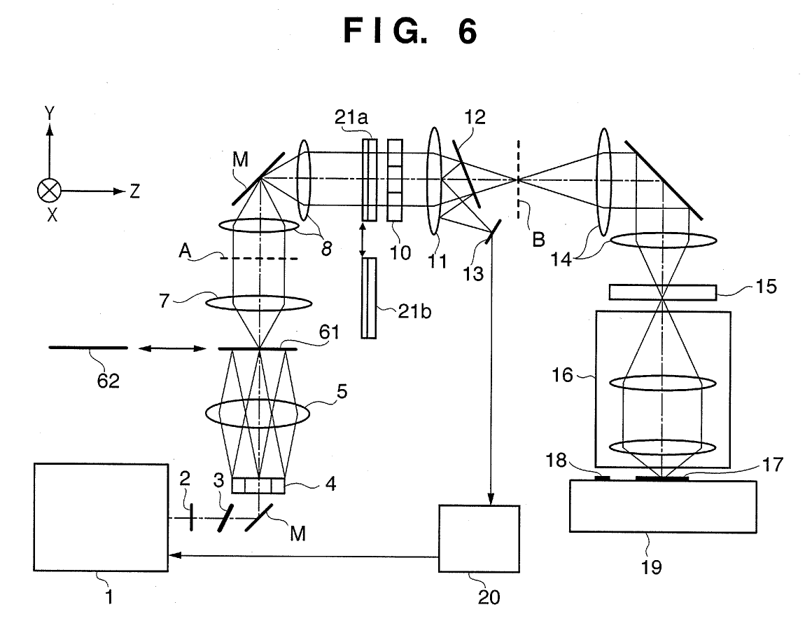

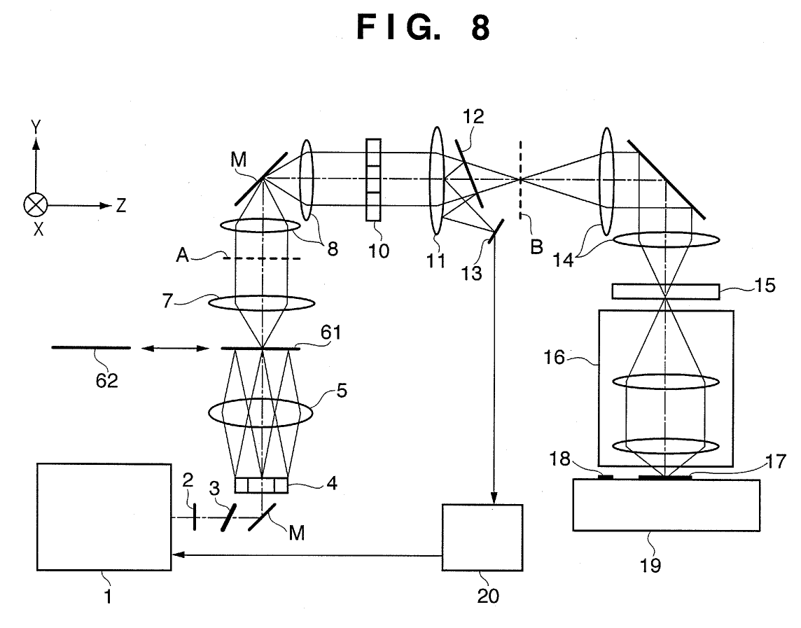

FIGS. 5A, 5B, and 5C are views illustrating polarization states in custom polarization illumination. The first embodiment of the present invention is related to an exposure apparatus comprising a polarization optical element. The first embodiment provides an arrangement that can form a light intensity distribution exhibiting the polarization states as illustrated in FIGS. 5A, 5B, and 5C on the pupil plane of an illumination optical system. Referring to FIGS. 5A, 5B, and 5C, a white portion indicates a bright region, and an arrow indicates the polarization direction (the direction of an electric field vector) in this region. FIG. 6 is a view showing the schematic arrangement of an exposure apparatus according to the first embodiment of the present invention. The same reference numerals as in FIG. 8 denote the same constituent elements in FIG. 6, and a description thereof will not be repeated. An optical system formed by optical elements interposed between a light source 1 and a mask 15 to illuminate the mask 15 will be called an illumination optical system hereinafter. Referring to FIG. 6, however, not all the optical elements interposed between the light source I and the mask 15 are indispensable elements for the illumination optical system. The illumination optical system can include, as a constituent element, a waveplate or polarizer made of a birefringent glass material.

The polarization optical element 21, i.e., 21a or 21b exemplified with reference to FIGS. 4A, 4B, and 4C is built in the illumination optical system. The polarization optical element 21 can be inserted in a region where the incident angle of a light beam becomes 1° or more.

The polarization optical element 21 has a sub wavelength structure having a cycle equal to or less than the wavelength of exposure light emitted by the light source 1. The polarization optical element 21 is preferably selected from two or more polarization optical elements 21a or 21b and inserted in the optical path of the illumination optical system. The polarization optical element 21 having the sub wavelength structure may be arranged at an arbitrary position in the illumination optical system as long as a light intensity distribution exhibiting the polarization states as illustrated in FIGS. 5A, 5B, and 5C is formed on the pupil plane of a projection optical system 16 as an effective light source. However, the polarization optical element 21 is preferably arranged near or on the pupil plane of the illumination optical system. Referring to FIG. 6, the polarization optical element 21 is arranged near the incident surface of a fly-eye lens 10 having an exit surface arranged on the pupil plane of the illumination optical system. Assume that light applied from the light source 1 is polarized light having an electric field vector in a direction perpendicular to the sheet surface, i.e., in the X direction. In this case, the polarization optical element 21 receives the polarized light having an electric field vector in a direction perpendicular to the sheet surface.

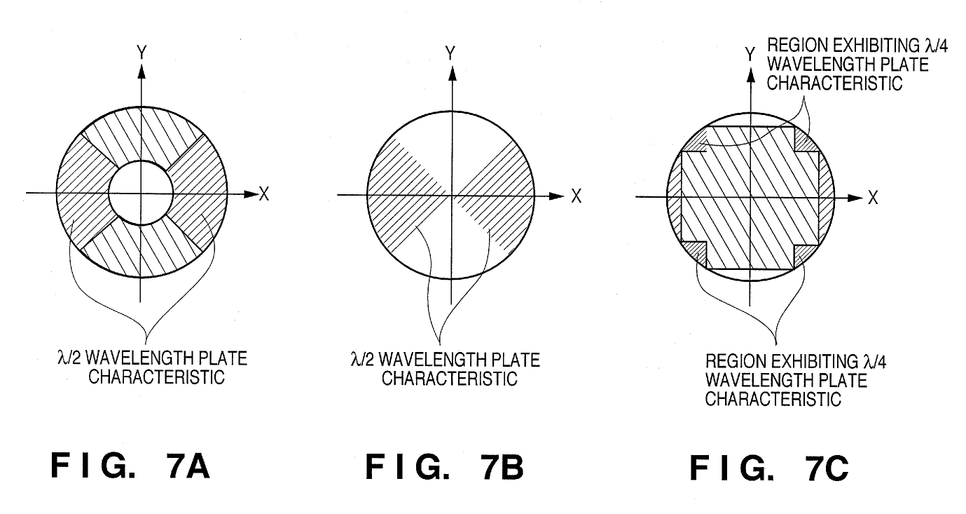

To obtain polarization illumination in which the polarization direction in two regions on the pupil plane of the illumination optical system is the Y direction (a direction parallel to the sheet surface in FIG. 6) as shown in FIG. 5A, it suffices to convert an X-polarized light component into a Y-polarized light component using a half wavelength plate having a fast axis in the X-Y direction (the 45° direction with respect to the X-axis) in the two regions. As shown in FIG. 7A, the polarization optical element for converting an X-polarized light component to a Y-polarized light component need only have a sub wavelength structure that extends in the 45° direction (or the 135° direction) and has a cycle equal to or less than the wavelength (a black portion indicates a valley portion formed by etching). The polarization optical element having the sub wavelength structure shown in FIG. 7A acts as a half waveplate having a fast axis in the 45° direction to be able to convert an X-polarized light component into a Y-polarized light component. Using such a polarization optical element makes it possible to obtain the polarization state as shown in FIG. 5A on the pupil plane of the illumination optical system.

Assume polarization illumination for controlling the polarization states in four regions and, more specifically, two regions including the X-axis and two regions including the Y-axis on the pupil plane of the illumination optical system, as shown in FIG. 5B. To obtain this polarization illumination, as shown in FIG. 7B, it suffices to use a polarization optical element having the following structure. That is, a sub wavelength structure extending in the 45° direction is formed in two regions including the X-axis, while no sub wavelength structure is formed in two regions including the Y-axis, where the polarization state of exposure light need not be converted.

Assume polarization illumination for controlling the polarization states in eight regions on the pupil plane of the illumination optical system, as shown in FIG. 5C. To obtain this polarization illumination, as shown in FIG. 7C, it suffices to form a sub wavelength structure extending in the 45° direction so that a Y-polarization conversion region exhibits a half wavelength plate characteristic having a fast axis in the 45° direction without forming any sub wavelength structure in an X-polarization conversion region. Also, it suffices to form a sub wavelength structure extending in the 45° direction so that a circular polarization conversion region exhibits a λ/4 wavelength plate characteristic having a fast axis in the 45° direction. To impart the λ/4 wavelength plate characteristic, it suffices to change the depth or density of a sub wavelength structure as compared to a half wavelength plate region.

The sub wavelength structure of a polarization optical element need only be determined to change the density between the direction of the middle (corresponding to the equiangular bisector) between the polarization direction of incident light on the polarization optical element and that of the exit light from the polarization optical element and a direction perpendicular to the middle direction.

### Second Embodiment

A polarization optical element having a sub wavelength structure according to the present invention exhibits a desired waveplate characteristic even when the incident angle is large. This makes it possible to set a polarization optical element having a waveplate effect at a place where a conventional waveplate made of a birefringent glass material cannot be set.

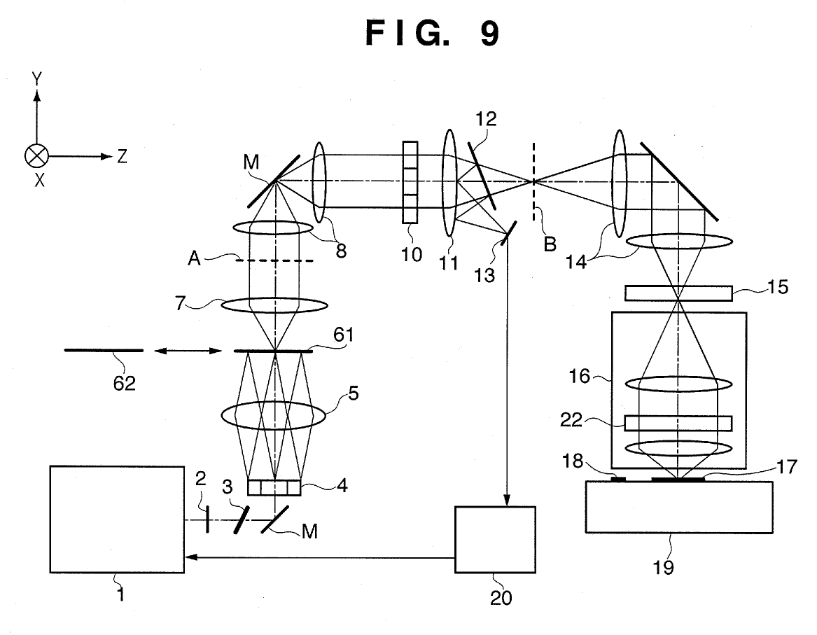

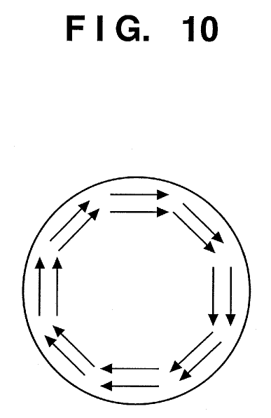

FIG. 9 is a view showing the schematic arrangement of an exposure apparatus according to the second embodiment of the present invention. The same reference numerals as in FIG. 8 denote the same constituent elements in FIG. 9, and a description thereof will not be repeated. In the second embodiment, a polarization optical element 22 having the sub wavelength structure exemplified with reference to FIGS. 4A, 4B, and 4C is arranged near the pupil plane of a projection optical system 16. To expose a substrate 17 with an S-polarized light component, the polarization optical element 22 is desirably set to achieve a polarization state as shown in FIG. 10, in which the polarization direction is tangential to each place on the pupil plane of the projection optical system 16.

### Third Embodiment

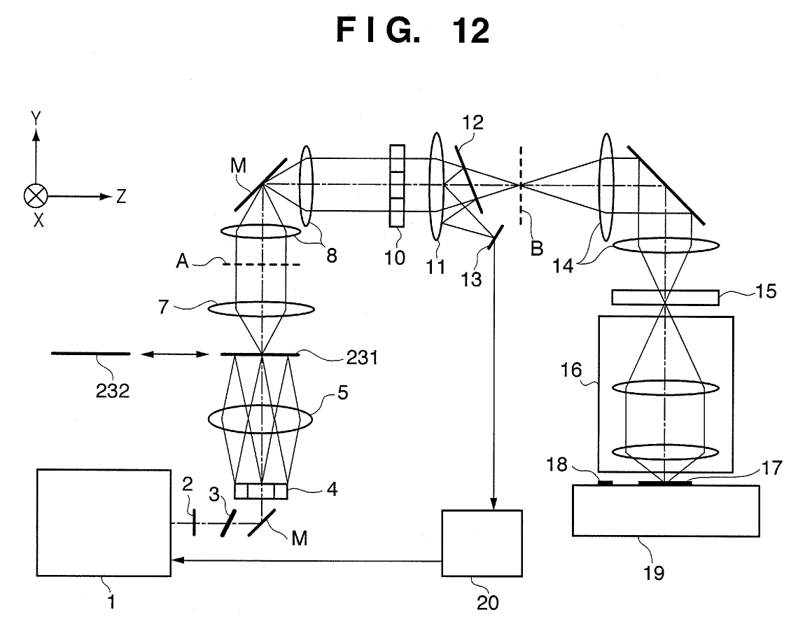

A polarization optical element having a sub wavelength structure according to the present invention is also applicable to a CGH. FIG. 12 is a view showing the schematic arrangement of an exposure apparatus according to the third embodiment of the present invention. The same reference numerals as in FIG. 8 denote the same constituent elements in FIG. 12, and a description thereof will not be repeated. In the third embodiment, a polarization optical element having a sub wavelength structure is added to a CGH.

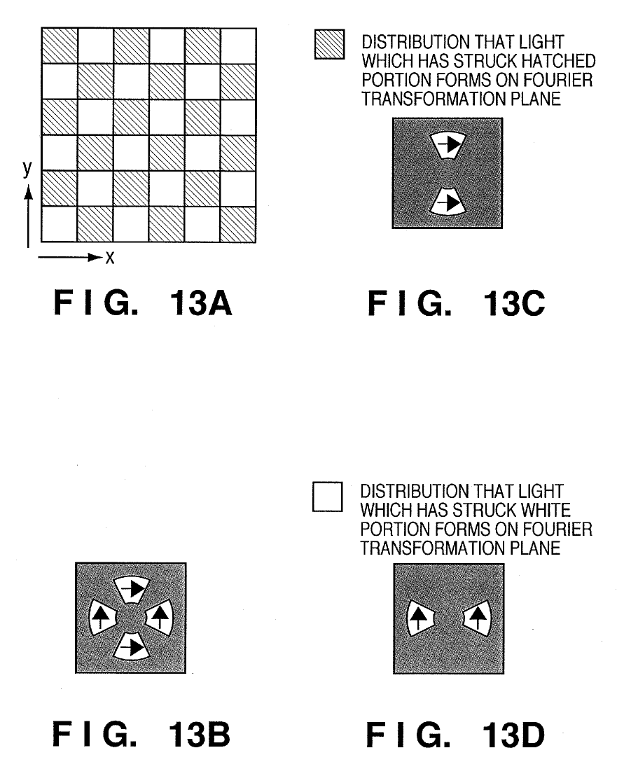

In the third embodiment, a hologram 231 to which a polarization optical element having the sub wavelength structure exemplified with reference to FIGS. 4A, 4B, and 4C is added substitutes for the CGH 61 (FIG. 8). FIGS. 13A, 13B, 13C, and 13D are views for explaining the hologram 231 to which the polarization optical element having the sub wavelength structure is added. Assume that an effective light source distribution as shown in FIG. 13B is formed on the pupil of an illumination optical system. FIG. 13B illustrates quadrupole illumination in which the electric field vector in each region is in a direction tangential to the distribution. FIG. 13A illustrates the hologram 231 to which a polarization optical element in this case is added when seen from the optical axis direction. As shown in FIG. 13A, the pattern of the CGH is divided into several regions (indicated by hatched regions and white regions in FIG. 13A). An x-polarized light component strikes the hologram 231 to which the polarization optical element is added.

Not a polarization optical element but only a CGH pattern is formed in the hatched region. As shown in FIG. 13C, in two regions aligned vertically of quadrupole four regions, light which has struck the hatched region forms a distribution having an electric field vector in the x direction that is the same as the polarization direction of the incident light. In the white region, a CGH pattern and a polarization optical element having a sub wavelength structure are formed. The sub wavelength structure exhibits a half waveplate characteristic having a fast axis in the x-y direction (45° direction). As shown in FIG. 13D, light which has struck the white region forms a distribution having an electric field vector in the y direction in two regions aligned horizontally of the quadrupole four regions.

A polarization optical element may be formed either on the CGH pattern or a region corresponding to the lower surface of the CGH pattern.

A polarization optical element 232 having another CGH pattern and polarization optical characteristic is desirably arranged exchangeably with the hologram (polarization optical element) 231.

### Fourth Embodiment

A method of manufacturing a polarization optical element having a sub wavelength structure will be exemplified. A hard mask made of, e.g., Cr is formed on a glass substrate. A photosensitive agent is applied on the hard mask. A micropattern is transferred onto the photosensitive agent using a projection exposure apparatus. The micropattern is developed. The hard mask is etched and patterned through the opening of the micropattern by an etcher. The glass substrate is etched by an etcher using the patterned hard mask as a mask.

The etching scheme becomes less suitable as the etching depth increases. A polarization optical element having a sub wavelength structure generates a phase difference that depends on the depth. Failure in deep makes it impossible to manufacture a polarization optical element which generates a desired phase difference. To prevent this problem, if a phase difference generated by one polarization optical element having a sub wavelength structure is smaller than a desired amount, a plurality of polarization optical elements may be arranged in series to obtain a desired phase difference. Assume, for example, that one wants a half waveplate but a polarization optical element having a sub wavelength structure is relatively expensive due to difficult etching. In this case, two quarter waveplates that are inexpensive and whose etching depth is shallow can be superimposed on each other so that they act as a half waveplate.

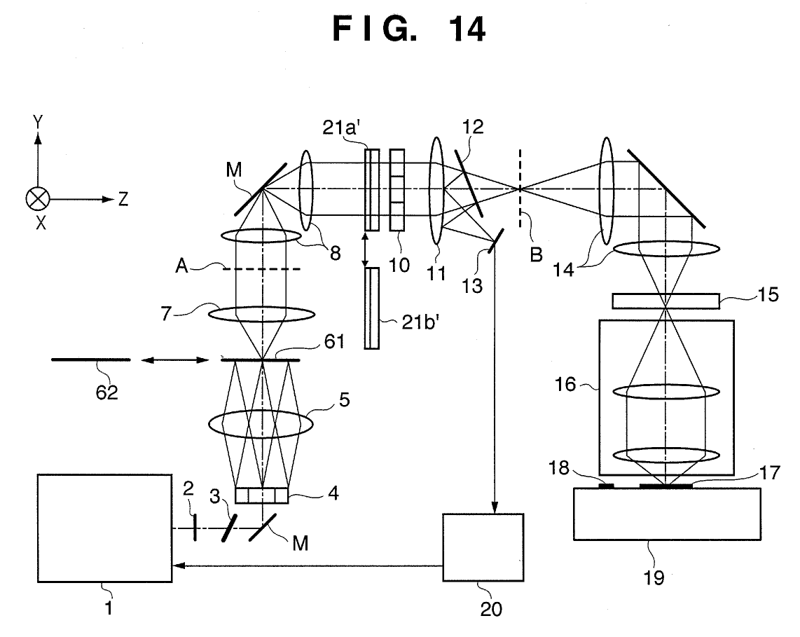

As shown in FIG. 14, a pair of polarization optical elements 21a′ or 21b′ arranged in series along the optical path can substitute for the polarization optical elements 21a or 21b according to the first embodiment.

As described above, it is possible to easily, inexpensively, and efficiently attain arbitrary polarization illumination by combining a plurality of polarization optical elements having a sub wavelength structure.

### APPLICATION EXAMPLE

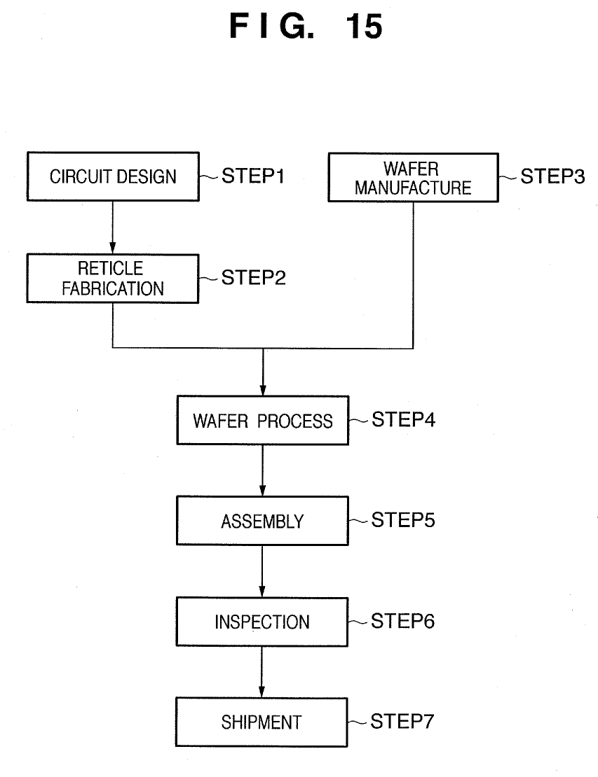

A device manufacturing method using the above-described exposure apparatus will be described next. FIG. 15 is a flowchart illustrating the sequence of the overall semiconductor device manufacturing process. In step 1 (circuit design), the circuit of a semiconductor device is designed. In step 2 (reticle fabrication), a mask (also called a reticle or original) is fabricated on the basis of the designed circuit pattern. In step 3 (wafer manufacture), a wafer (also called a substrate) is manufactured using a material such as silicon. In step 4 (wafer process) called a preprocess, an actual circuit is formed on the wafer by lithography using the reticle and wafer. In step 5 (assembly) called a post-process, a semiconductor chip is formed using the wafer manufactured in step 4. This step includes processes such as assembly (dicing and bonding) and packaging (chip encapsulation). In step 6 (inspection), inspections including operation check test and durability test of the semiconductor device manufactured in step 5 are performed. A semiconductor device is completed with these processes and shipped in step 7.

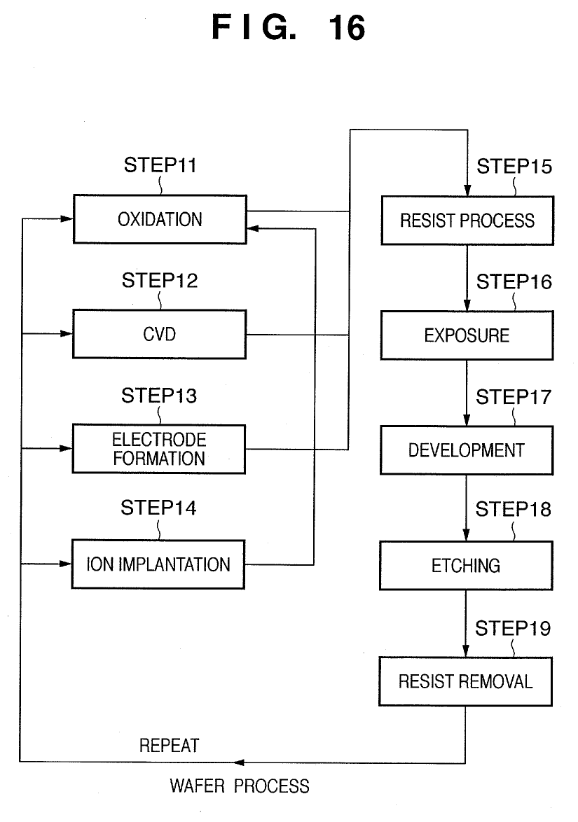

FIG. 16 is a flowchart illustrating the detailed sequence of the wafer process. In step 11 (oxidation), the wafer surface is oxidized. In step 12 (CVD), an insulating film is formed on the wafer surface. In step 13 (electrode formation), an electrode is formed on the wafer by deposition. In step 14 (ion implantation), ions are implanted into the wafer. In step 15 (resist process), a photosensitive agent is applied to the wafer. In step 16 (exposure), the above-described exposure apparatus is used to form a latent image pattern on the resist by exposing the wafer coated with the photosensitive agent to light via the mask on which the circuit pattern is formed. In step 17 (development), the resist transferred onto the wafer is developed to form a resist pattern. In step 18 (etching), the layer or substrate under the resist pattern is etched through a portion where the resist pattern opens. In step 19 (resist removal), any unnecessary resist remaining after etching is removed. By repeating these steps, a multilayered structure of circuit patterns is formed on the wafer.

In this case, the device can include, e.g., a semiconductor device, liquid crystal display device, image sensing device (e.g., CCD), or thin-film magnetic head.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-221241, filed Aug. 14, 2006, which is hereby incorporated by reference herein in its entirety.

What is claimed is:

1. An exposure apparatus comprising:
an illumination optical system configured to illuminate a mask with light from a light source; and
a projection optical system configured to project a pattern of the mask illuminated by said illumination optical system onto a substrate,
wherein said illumination optical system includes an optical integrator configured to emit plurallight fluxes from an exit surface of said optical integrator, a diffraction optical element configured to form a predetermined light intensity distribution on an incident surface of said optical integrator, and a polarization optical element configured to adjust a polarization state of an incident light,
said polarization optical element has a pattern with which said polarization optical element functions as a birefringent element, the pattern with different density between a first direction and a second direction perpendicular to the first direction, and having a sub wavelength structure having a cycle not more than a wavelength of the light from the light source, and
said polarization optical element is arranged near or on the incident surface on which said diffraction optical element forms the light intensity distribution.

2. The apparatus according to claim 1, wherein a plurality of said polarization optical element are arranged in series in an optical path from the light source to the mask.

3. The apparatus according to claim 2, wherein the plurality of said polarization optical element function as a half waveplate.

4. The apparatus according to claim 1, wherein said sub wavelength structure includes a pyramid.

5. An exposure apparatus comprising:
an illumination optical system configured to illuminate a mask with light from a light source;
a projection optical system configured to project a pattern of the mask illuminated by said illumination optical system onto a substrate; and
a polarization optical element which is built in said projection optical system and configured to adjust a polarization state of an incident light,
wherein said polarization optical element has a pattern with which said polarization optical element functions as a birefringent element, the pattern with different density between a first direction and a second direction perpendicular to the first direction, and having a sub wavelength structure having a cycle not more than a wavelength of the light from the light source.

6. A device manufacturing method comprising the steps of:
exposing a substrate coated with a photosensitive agent to light using an exposure apparatus defined in claim 1; and
developing the exposed substrate.
